(19) United States
(12) Patent Application Publication
(10) Pub. No.: US 2015/0067334 A1
(43) Pub. Date: Mar. 5, 2015

(54) DELIVERING DATA OVER A NETWORK

(71) Applicant: QANDO SERVICE INC., Tortola (VG)

(72) Inventors: Iskender Syrgabekov, London (GB); Yerkin Zadauly, Almaty (KZ)

(21) Appl. No.: 14/382,173

(22) PCT Filed: Feb. 27, 2013
(86) PCT No.: PCT/EP2013/053964

§ 371 Date: Aug. 29, 2014

(30) Foreign Application Priority Data
Feb. 29, 2012 (GB) 1203558.0

(51) Int. Cl. H04L 29/06; H04L 29/08

(52) U.S. Cl. CPC H04L 63/0435; H04L 67/10; H04L 63/061
USPC 713/171; 709/217

(57) ABSTRACT

A method and system for storing and delivering content data over a network comprising receiving a request over a network for content data from a requester (20), the request including enablement information to enable retrieval of the content data from one or more storage locations. Processing the enablement information to determine data allocation within the one or more storage locations. Retrieving content data in the form of separate data components (90) from the one or more storage locations according to the determined data allocation. Sending to the requester (20) the separate data components (90).

### FIELD OF THE INVENTION

The present invention relates to a system and method for sending and receiving content data across a network and in particular, web pages across the Internet.

### BACKGROUND OF THE INVENTION

Technology for providing content data from a web server to a browser across a network such as the Internet is well known. For simple static web pages, HTML data may be stored on the web server and provided to one or more browsers upon request. For example, a URL may be typed into a browser, which specifies the location of the requested content. A web server at that location then responds by providing the requested content data or HTML web page.

For more complex content, especially where interaction between a user operating the browser and the web server is required then server side or client side processing may take place. Under these circumstances, the request from the browser may include data sent to the web server forming two way communication.

This two way communication may include sensitive or valuable information and so various types of encryption involving symmetric keys, public key and private key, and digital signatures may be used. The data (transmitted and received over the Internet) may be readily intercepted but decryption may involve significant overheads. Nevertheless, the web server itself must have access to the unencrypted data at some point during processing in order to meet the browser requests. Therefore, the web server or database storing content may become vulnerable to attack as they contain a concentration of valuable or sensitive information.

Furthermore, the web server or group of web servers may become vulnerable to denial of service type attacks where a volume of requests is initiated that can overwhelm the resources of the web server or group of web servers. Under such attacks or under especially high traffic volumes, requests from browsers may go unfulfilled.

Certain countries may wish to restrict access to areas of the Internet by blocking or filtering incoming web traffic. The web traffic may include news and other public information that is not encrypted, making it straightforward for such regimes to restrict legitimate access. Individual browsers or groups of browsers may be monitored to determine if they are attempting access to such material, leading to significant censorship. Therefore, users of browsers and web servers supplying content data to them may prefer to avoid such monitoring of activity.

Therefore, there is required a system of providing content data that overcomes these problems.

### SUMMARY OF THE INVENTION

In accordance with a first aspect there is provided a method of delivering content data over a network comprising the steps of:

receiving a request over a network for content data from a requester, the request including enablement information to enable retrieval of the content data from one or more storage locations;

processing the enablement information to determine data allocation within the one or more storage locations;

retrieving content data in the form of separate data components from the one or more storage locations according to the determined data allocation; and

sending to the requester the separate data components. Therefore, the content data, which may be used to render a web page, for example, may be sent more securely and/or reliably. The enablement information may alternatively be described as access information, location data, an identifier of these items or a key to decrypt or render readable such information, for example.

Optionally, the enablement information may comprise one or more of: data allocation information; encrypted data allocation information; and a decryption key for decrypted data allocation information. In other words, the request may include information enabling a server or processor to find and retrieve the separate data components from the one or more storage locations. Where a key is sent then data allocation information may be stored local to the processor (or server) or elsewhere, but only accessible to the processor on receipt of a valid key. Enabling retrieval of the separate data components may also include providing an indication of which set of allocation data (e.g. FAT table) out of many alternatives to use to respond to a particular request.

Optionally, processing the enablement information may further comprise the step of decrypting encrypted data allocation information using a decryption key.

Optionally, the request may be received over the Internet and separate data components may be sent over the Internet. The request and/or data may be sent using HTTP, for example. The network may use the internet protocol, for example.

Preferably, the storage locations may be separate storage locations. They may be physically and/or logically separate, for example. They may be provided with addresses or unique addresses such as IP addresses, for example.

Optionally, the separate storage locations may be physically and/or remote separate storage locations.

Optionally, processing the enablement information to determine data allocation further comprises generating a file allocation table. Processing may include reading, decrypting or using the supplied information to identify and/or decrypt information from other sources, for example.

Preferably, the separate data components may be sent together with data component identifiers. This facilitates more convenient restoration of the data or payload (reconstructed content data sent in response to the request).

Optionally, the separate data components may include parity data such that any one or more of the separate data components are recreatable from the remaining separate data components and the parity data. The parity data may be stored, transmitted to the requester, referenced by the data allocation information or otherwise handled in the same way as the separate data components.

Advantageously, the content data may comprise any one or more of: page layout, design elements, video, graphics, audio and web page content.

According to a second aspect there is provided method of retrieving content data across a network, the method comprising the steps of:

requesting for content data from a server, the request including enablement information to enable retrieval of the content data from one or more storage locations;

receiving in response to the request of the separate data components; and

generating the content data from the separate data components.

Preferably, generating the content may further comprise reconstructing the content data from a data map providing an indication of how the separate data components form the content data. The data map may also be received in response to the request.

Optionally, the separate data components may include parity data and wherein generating the content data further comprises the steps of:

regenerating any missing data components from the parity data and the remaining data components; and

reconstructing the received data components and any regenerated missing data components to form the content data. This improved reliability may be especially apparent when data components are susceptible to becoming unavailable due to loss on route or could not be retrieved from where they were stored (the storage locations may be removed from the network, for example).

Optionally, a data map describes which parity data corresponds with which data components.

According to a third aspect there is provided a server comprising:

a network interface; and

logic configured to:
receive a request over a network for content data from a requester, the request including enablement information to enable retrieval of the content data from one or more storage locations;
process the enablement information to determine data allocation within the one or more storage locations;
retrieve content data in the form of separate data components from the one or more storage locations according to the determined data allocation; and
send to the requester the separate data components. In this sense a server responds to requests received from a network. The server may be web server, for example.

Optionally, the logic to process the enablement information may be further configured to decrypt encrypted data allocation information using a decryption key.

According to a fourth aspect there is provided a client for retrieving content data across a network, the client comprising logic configured to:

request for content data from a server, the request including enablement information to enable retrieval of the content data from one or more storage locations;

receive in response to the request of the separate data components; and

generate the content data from the separated data components. The client may be a browser, terminal, mobile terminal or any processor making requests for data across a network.

Preferably, the logic configured to generate the content data from the separated data components may further comprise logic configured to:

reconstruct the content data from a data map providing an indication of how the separate data components form the content data.

Preferably, the data components may include identifiers corresponding to identifiers within the data map.

Advantageously, the separate data components may include parity data and wherein the logic configured to generate the content data further comprises logic configured to:

regenerate any missing data components from the parity data and the remaining data components; and

reconstruct the received data components and any regenerated missing data components to form the content data.

Preferably, the client may further comprise logic configured to generate a web page from the content data.

According to a fifth aspect there is provided a method of storing content data comprising the steps of:

dividing the content data into a plurality of separate data components;

storing the separate data components within one or more storage locations;

generating data allocation information describing how the separate data components are allocated within the one ore more storage locations; and

generating a data map providing an indication of how the separate data components form the content data. Therefore, the content data may be stored more securely.

Preferably, the method may further comprise the step of generating an identifier for each separate data component and wherein the data map includes in its indication the identifiers for the separate data components.

Optionally, the method may further comprise the step of encrypting the data allocation information and/or the data map.

Preferably, the content data may be web content.

Optionally, the method may further comprise the step of:

generating parity data for each data component and another data component of the plurality of message components.

Optionally, the method may further comprise the step of:

generating parity data for each data component and a second other data component of the plurality of data subsets.

Preferably, the method may further comprise the step of storing the generated parity data in the one or more storage locations. The parity data (or redundant data) may then be treated and processed in a similar way to the data components.

The methods described above may be implemented as a computer program comprising program instructions to operate a computer. The computer program may be stored on a computer-readable medium or transmitted as a signal. The logic may be provided as software, firmware, installed instructions or received as scripts, for example.

### BRIEF DESCRIPTION OF THE FIGURES

The present invention may be put into practice in a number of ways and embodiments will now be described by way of example only and with reference to the accompanying drawings, in which:

FIG. 1 shows a schematic diagram of a system for sending content data from a web server to a browser, given by way of example only;

FIG. 2 shows a schematic diagram of a system for providing content data from the web server of FIG. 1 to the browser;

FIG. 3 shows a flow diagram of a method for storing content data including a dividing step;

FIG. 4 shows a flow diagram of a method for sending the stored content data of FIG. 3 to the browser;

FIG. 5 shows a flow diagram of a method for requesting content data including a data regenerating step;

FIG. 6 shows a schematic diagram indicating a method for generating parity data as part of the dividing step of FIG. 3, given by way of example only;

FIG. 7 shows a schematic diagram of an illustrative method of the data regenerating step of FIG. 5 and using parity data generated in accordance with the method shown in FIG. 6; and

FIG. 8 shows a schematic diagram of a further illustrative method for reconstructing missing data as part of the combining step of FIG. 5 and using the parity data generated using the method of FIG. 6.

It should be noted that the figures are illustrated for simplicity and are not necessarily drawn to scale.

### DETAILED DESCRIPTION OF THE PREFERRED EMBODIMENTS

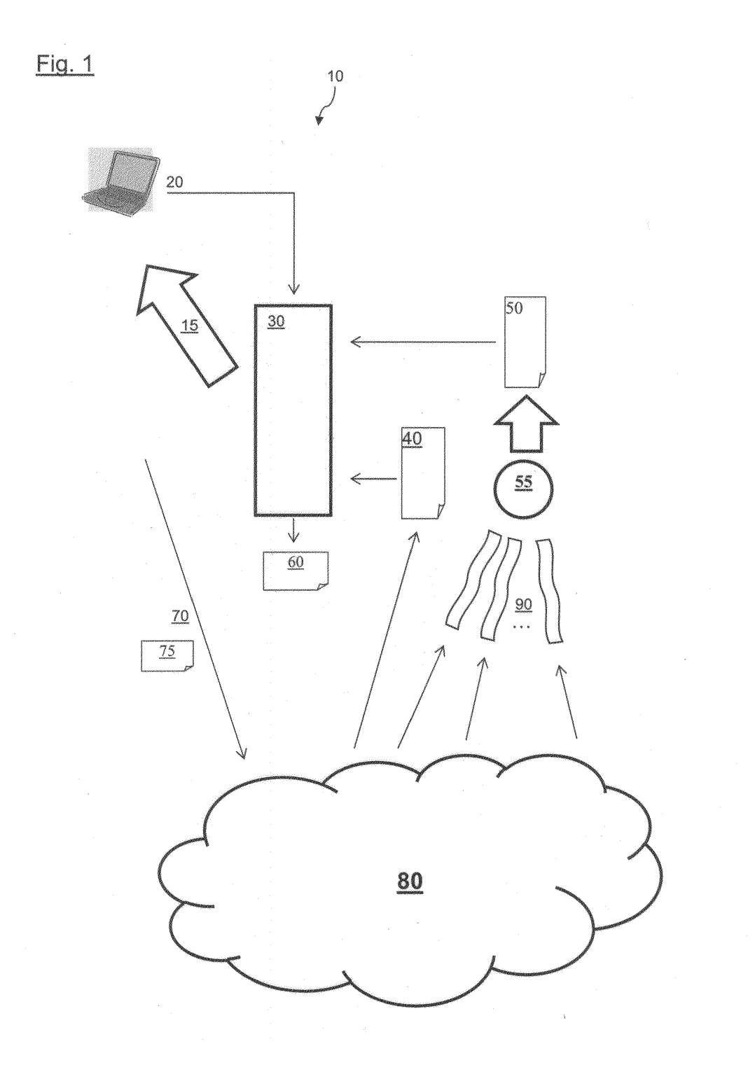

FIG. 1 shows a high level schematic diagram of a system 10 for providing content data 15 to a terminal, client or browser 20.

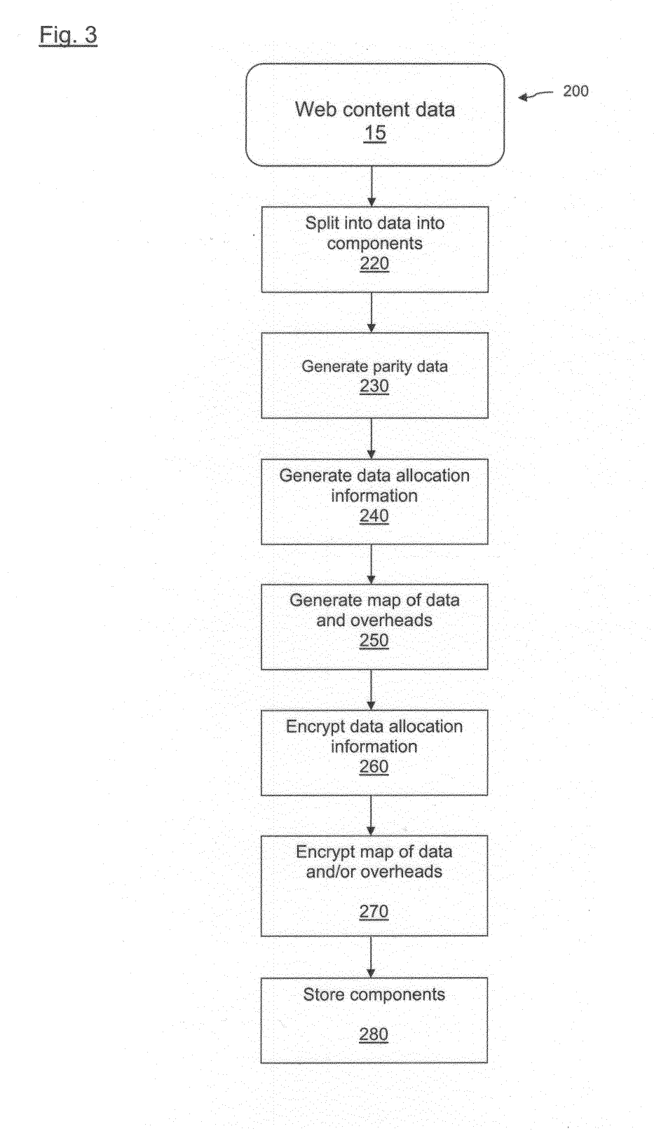

The content data 15 itself may reside in a distributed storage system 80 as separate data components 90 forming the content data 15. Division of the content data 15 into the separate data components 90 is described with reference to FIG. 3 later on.

In order to retrieve the content data 15, the browser 20 issues a request 70 that includes enablement information or a key enabling or allowing the distributed storage system 80 to retrieve the particular data components 90. Without this enablement information, the server may not be able to retrieve the content data due to security restrictions or simply because the server would not have enough information to determine what particular data to retrieve or where to retrieve it from. These data components 90 may be stored separately and so the enablement information may provide the system with the information required to determine the allocation and location of the data components 90 within the storage system 80 or provide the system with access to this allocation information.

For example, the enablement information may include a cryptographic key that may be used to decrypt a file allocation table (FAT), describing the allocation of data within storage system 80. Alternatively, the request 70 may include the file itself either encrypted or as plain text, depending on security requirements. The storage system may include multiple separate and remote storage devices and the separate data components 90 may be distributed amongst these different and/or remote storage locations.

Preferably, within the client or browser 20, processing may take place to join the separate data components 90 to provide content data that may be read and rendered successfully and correctly.

For processing logic 55 may provide the initial combining steps producing a single set of data 50, which may be considered to be a payload, for example.

Along with the separate data components 90, the distributed storage system 80 may provide additional information or overheads 40 to the requesting browser 20. For example, these overheads 40 may include identifiers for each separate data component 90, a data map describing an indication of how the separate data components 90 may form the resultant content data (e.g. a web page). For example, the payload 50 may include text, features, and other media. Any overheads 40 may provide an indication or information as to how the payload should be reconstructed and rendered. This takes place in post processor 30, which receives the payload 50, the overhead and preferably a decryption key (which may be the same or different to that formed provided in the request 70). This decryption key may be used to decrypt aspects or the entire set of overheads 40 producing a map of data 60 to be used via the post processor 30 to compile and/or render the content data 15 in its correct form to be displayed or played to the user.

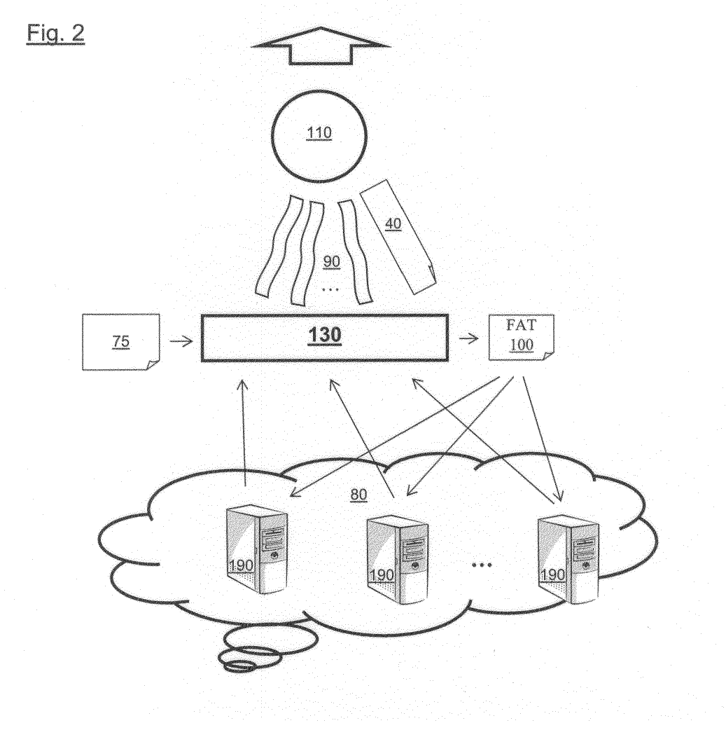

FIG. 2 shows a schematic diagram providing more detail describing how the request 70 from the browser 20 is met by the distributed storage system 80. The distributed storage system 80 may include several storage devices 190, which may also act as separate web servers. In this embodiment, the request 70 from the browser 20 includes a key 75, which may be used within a processor 130 executing logic to enable decryption of the FAT 100. Processor 130 may also comprise a web server or other server-type functionality. The processor 130 uses the decrypted FAT 100 to locate and retrieve the separate data components 90 from the separate storage locations 190 within the distributed storage system 80. The individual storage locations 190 may be separated across a wide area such that local events disrupting or destroying individual storage devices 190 will not affect the remaining storage devices 190 within the distributed storage system 80.

Once the separate data components 90 have been retrieved from their storage devices, the processor 130 also retrieves the overheads 40 (either from an individual location or again, separate storage locations 190). This stack of data 110 is sent to the browser for processing.

FIG. 3 shows a flow chart of a method 200 for storing content data within the separate storage locations 190 of the distributed storage system 80. Content data 15 is split or divided into the data 220 components 90 at step 220. Parity data is generated for the separate data components at step 230. Generation of the parity data is described with reference to FIGS. 6 to 8. At step 240, data allocation information is generated. This data allocation information may be in the form of the FAT 100 described with reference to FIG. 2. The data allocation information describes how and where each data component is stored in the separate storage locations 190 and may be used when retrieving such separate data components 90. The data allocation information may be generated at the time of storage or in advance. In particular, the data allocation information may be specific to the web content data 15 being stored such that this particular item of content data is recoverable when stored within the distributed storage system 80.

In order to reconstruct the original web content data 15 from its separate data components 90, a map of data is generated at step 250. This map of data 60 may be used by the browser 20 to reconstruct and render the content data 15 as required. The separate data components 90 may have assigned one or more, or perhaps each of them, an identifier that is referenced in the map of data 60. Therefore, during or preferably before this step, such overheads may also be generated. The identifiers may be reference both within the FAT 100 and the data map 60.

The data allocation information or FAT 100 may be encrypted at step 260 to improve security. Furthermore, the map of data and/or overheads may be encrypted at step 270 also to improve security.

In the meantime, or whilst the previous steps are taking place, the separate data components 90 may be stored within the allocated storage devices 190 in accordance with the allocation data allocation information or FAT 100.

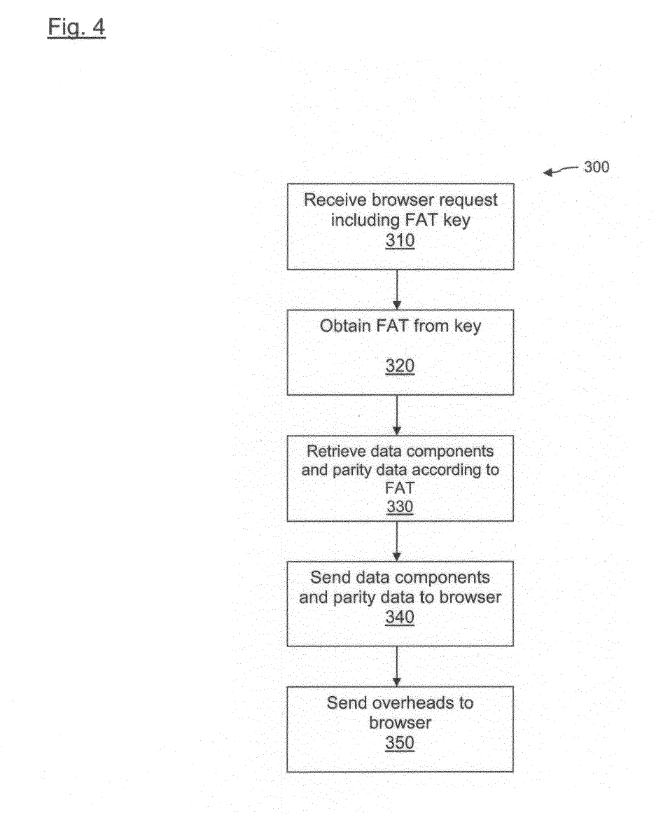

FIG. 4 shows a flowchart for responding to a browser request for data content 15 issued by a browser 20. This method 300 may be executed by a processor 130, for example.

A browser request including the FAT key 75 may be received at step 310. At step 320, the FAT 100 may be obtained using the FAT key 75, preferably during a decryption procedure. A FAT 100 may provide the data allocation information generated at step 240 of method 200. This FAT 100 may be stored locally within the processor 130, but only decryptable on receipt of the key 75 by accompanying the request 70, for example. In other words, the request includes enablement information to enable retrieval of the content data from one or more storage locations and this enablement information in this particular example is in the form of a decryption key 75.

At step 330, the data components and any accompanying parity data may be retrieved according to the FAT 100 from the separate storage devices 190. These retrieved data components and parity data are sent to the requesting browser 20 at step 340. At the same time or separately, the overheads, including data component identifiers are also sent to the requesting browser at step 350.

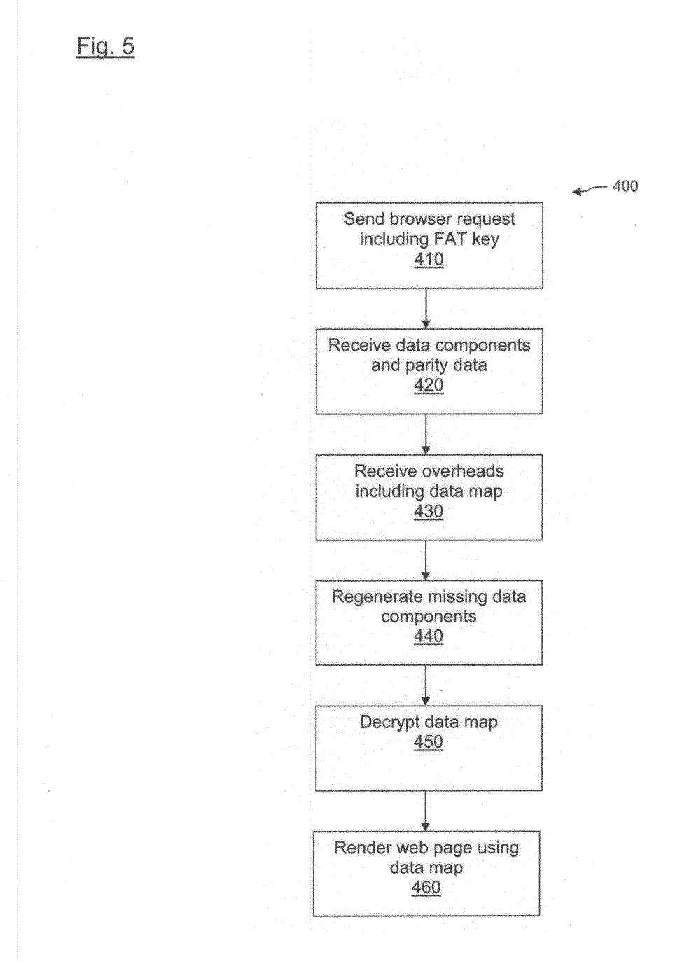

FIG. 5 shows a flow chart of a method 400 carried out within the browser 20 for requesting and then rendering content data. The browser sends a request at step 410. This request includes the FAT key 75. In response to this request, data components and parity data are received at step 420. Furthermore, the overheads 40 and data map information are received at step 430. Any missing data components are regenerated or recreated at step 440. An example regeneration procedure is described in further detail with reference to FIGS. 5, 6, 7 and 8, which uses the received parity data as well as any remaining or available data components.

As the data map 60 is in encrypted form, the data map may be decrypted at step 450. The received data components 90 and any regenerated data components are used to restore the payload 50 forming the original information. The decrypted data map 60 along with the overheads 40 (data component identifiers) are used to render and form the resultant web page at step 460 for display or play to a user.

Simple division of the content data may be used to generate message components of equal or substantially equal size or length. However, in order to improve security and/or data recovery then more complex error correcting or secure algorithms may be used in this procedure. Corresponding regeneration or combining algorithms or collating steps may be used when receiving the content data. To aid reliability, the components may include parity data generated as described with reference to FIGS. 6, 7 and 8. As an example, this processing may occur within or as part of the core processing logic 55.

For example, parity data may be generated using the exclusive OR function (XOR). e.g.:

(A)0100̂(B)0010=(P)0110 equation 1

where ̂ is the XOR function.

Should either data set A or B (i.e. data component) be lost, then the missing data may be reconstructed from the remaining data and the parity data (P) using the same XOR function, for example:

(A)0100̂(P)0110=(B)0010 equation 2

In order to generate redundant data to protect a particular message or data set, then this original data (F) may be divided into equal blocks or subsets. This may be represented as:

F{1,2,3, . . . n} equation 3

Parity data may be generated as:

1̂2,3̂4, . . . (n−1)̂n equation 4

FIG. 6 shows a method 1000 for generating more robust sets of parity data. This method 1000 allows for a greater number of data subset (and/or parity data) losses before the data becomes unrecoverable. The solid numbered circles 1, 2, 3, . . . n, represent data subsets formed by dividing the original data. Two sets of parity data are generated for each data subset. Each data subset is paired with another data subset and parity data is generated. The data subset is then paired with a different data subset and a further set of parity data is generated. In other words, each data subset is associated with two different other data subsets with parity data generated for each pairing. For example, in FIG. 6 this is shown as each data subset being paired with both of its neighbours (e.g. 2 paired with 1 and 2 also paired with 3). The first (1) and last (n) data subsets only have one neighbour (2 and n−1 respectively). Therefore, the first data subset is paired with the last data subset so that more than one set of parity data may be associated with the end data sets. However, any other combination and permutation may be used so that each data subset has at least two parity data sets associated with it. In notation form, this may be described as:

C{1̂2,3̂4, . . . (n−1)̂n,n̂1} equation 5

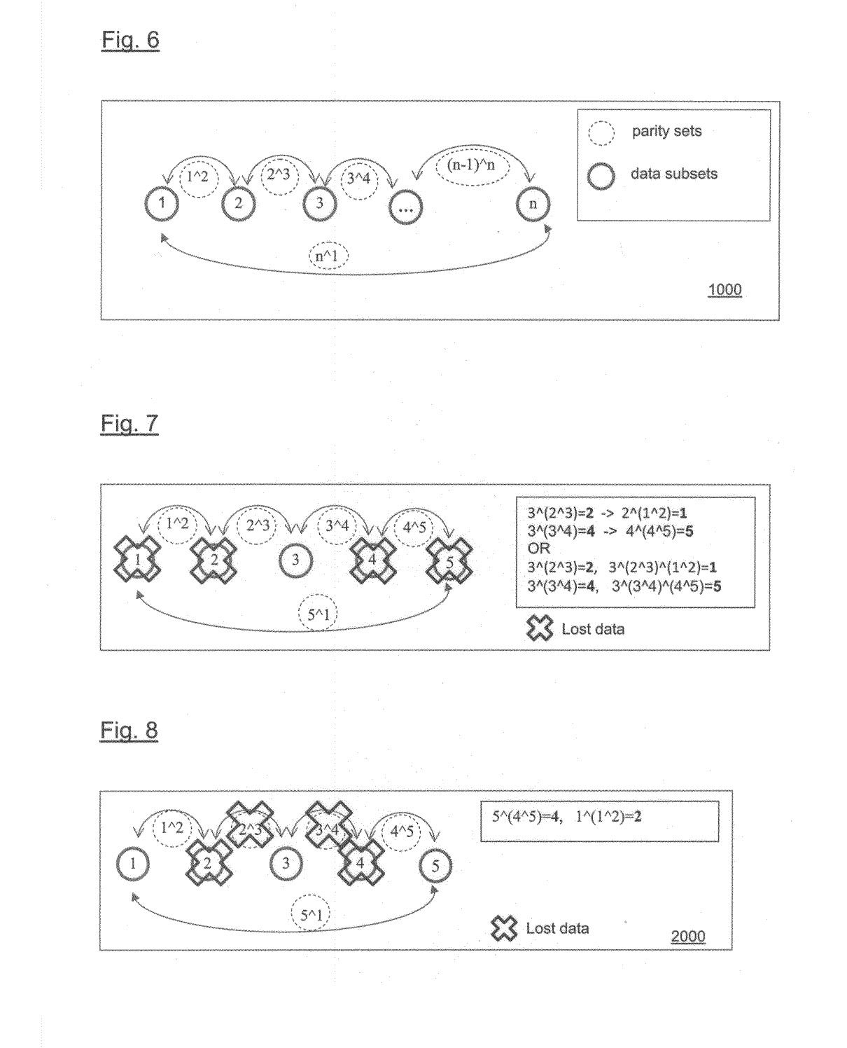

In an example where the original data are divided into five data subsets, the loss of four data subsets may still enable reconstruction of all of the original data provided that all of the parity data sets are retrievable. Such a situation is shown in FIG. 7, which schematically shows an example method 100 for reconstructing or regenerating missing data subsets.

In this example, the third data subset is available as well as the five parity data sets (1̂2, 2̂3, 3̂4, 4̂5 and 5̂1). The box in FIG. 7 shows two alternative ways in which each of the missing data subsets 1, 2, 4 and 5 may be reconstructed using the XOR function.

FIG. 8 shows a further example situation in which, five data subsets and created from original data but where two of the data subsets and two of the parity data sets (2̂3 and 3̂4) are lost or missing. In this particular reconstruction method 2000, the two missing data subsets 2 and 4 are recovered using the XOR operations shown in the side box.

In general terms, the loss of data subsets in any combination up to (n−1) may still result in all of the data being recoverable.

It is noted that the particular examples shown in FIGS. 7 and 8 are two of many alternative combinations and schemes for recovering data. Furthermore, it is noted that the cyclic approach shown in FIG. 6 for generating two parity data sets for each data subset is one of many alternatives. For example, each data subset may be paired with non-neighbouring subsets to form parity data.

When dividing the data into data subsets, a predetermined number of data subsets may be chosen. This may relate to the number of available or required storage locations (for each data subset and each parity data set) that are to be used, or separate data channels or other means of transmitting the data subsets from one location to another.

The data map 60 may be used to restore and allow rendering of the content data 15 in its desired format. Web pages may be provided as HTML (hypertext markup language). Under this standard, components of the page are labelled (markup) with tags enclosed in angle brackets “<” and “>”. For example the entire page starts with the tag “<html>” and closing tag “</html>”, the main contents page (page body) opens with the tag “<body>” and closing tag “</body>”. Service information may be specified in the tag “<meta>”, while scripts (executable scripts), executed on the page within the client's browser, may be enclosed in the tags “<script>” and “</script>”, etc.

As previously described, the payload 50 may contain media forming the web page (e.g. text, images and other elements). The payload 50 is stored and transmitted as separate data components 90. Other information forming the overheads 40 may be stored and transmitted as whole data (undivided). The data map 60 provides the information necessary to the client or browser 20 for restoring the separate data components 90 into the payload 40. The overheads 40 and/or the data map 60 may also contain information necessary to render the content data 15.

Data map 60 may include a set of identifiers for the data components 90 in the form of HTML tags. The data map 60 describes how the data components 90 are to be reassembled to form the payload 40.

The FAT 100 describes how the separate data components 90 from the original content data, are distributed across the distributed data storage system 80. Each separate data component may be assigned an identifier (which may be attached to it, provided as a header or embedded within it, for example). The FAT 100 may include a cross reference of identifier to location (this may also be an identifier such as an address or IP address, for example). Therefore, the FAT 100 provides the processor 130 with the information necessary to retrieve each separate data component.

Either or both the FAT 100 and data map 60 may be encrypted. Both files may have a particular format or grammar. Although any format or grammar may be used depending on specific requirements, the following example formats are provided.

An initialization file Microsoft (ini-files). These files consist of sections in square brackets and a set of parameters, e.g.:

[Name of Section]
Parameter = value
...

A popular format for providing data across the Internet is XML, which also includes tags similar to HTML. Within these tags are the parameters, e.g.:

```
<Name of Section>
<Parameter options=“value of Options”>
Name = Value;
    ...
  </Parameter>
</Name of Sections>
```

A further suitable format is JSON, in which data may be written as a name—value pair as well as arrays of values, e.g.:

```
“Parameter” : “Value”,
“Parameter” {
  “Name 1” : “Value 1”,
  “Name 2” : “Value 2”,
  “Name 3” : “Value 3,
```

As will be appreciated by the skilled person, details of the above embodiment may be varied without departing from the scope of the present invention, as defined by the appended claims.

For example, there may be any number of processors 130 (e.g. servers or web servers) including one or more. There may be any number of browsers or clients 20 including one or more. Other ways of dividing the data and/or generating parity data may be used including simple data separation.

There are many different ways of dividing and combining components to form the message other than those described which are provided as examples only. This includes simply dividing the data equally with padding provided optionally as necessary. There are also many different ways to generated parity data (if at all). These methods include applying the XOR logical function in different ways as well as using the Solomon-Reed function. Parity data may also be considered to be redundant data. In this context redundant data is data that is not necessary if all data components are available or safely received but they may be used to assist in regenerating or replicating any missing components or those that for some reason (e.g. corruption) are unavailable. Therefore, the terms parity data and redundant data may be used interchangeably.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

1. A method of delivering content data over a network comprising the steps of:
receiving a request over a network for content data from a requester, the request including enablement information to enable retrieval of the content data from one or more storage locations;
processing the enablement information to determine data allocation within the one or more storage locations;
retrieving content data in the form of separate data components from the one or more storage locations according to the determined data allocation; and
sending to the requester the separate data components.

2. The method of claim 1, wherein the enablement information comprises one or more of: data allocation information; encrypted data allocation information; and a decryption key for decrypted data allocation information.

3. The method of claim 1 or claim 2, wherein processing the enablement information further comprises the step of decrypting encrypted data allocation information using a decryption key.

4. The method of claim 1, wherein the request is received over the Internet and separate data components are sent over the Internet.

5. The method according to any previous claim, wherein the storage locations are separate storage locations.

6. The method of claim 5, wherein the separate storage locations are physically and/or remote separate storage locations.

7. The method of claim 5 or claim 6, wherein processing the enablement information to determine data allocation further comprises generating a file allocation table.

8. The method according to any previous claim, wherein the separate data components are sent together with data component identifiers.

9. The method according to any previous claim, wherein the separate data components include parity data such that any one or more of the separate data components are recreatable from the remaining separate data components and the parity data.

10. The method according to any previous claim, wherein the content data comprises any one or more of: page layout, design elements, video, graphics, audio and web page content.

11. A method of retrieving content data across a network, the method comprising the steps of:
requesting for content data from a server, the request including enablement information to enable retrieval of the content data from one or more storage locations;
receiving in response to the request of the separate data components; and
generating the content data from the separate data components.

12. The method of claim 11, wherein generating the content further comprises reconstructing the content data from a data map providing an indication of how the separate data components form the content data.

13. The method of claim 11 or claim 12, wherein the separate data components include parity data and wherein generating the content data further comprises the steps of:
regenerating any missing data components from the parity data and the remaining data components; and
reconstructing the received data components and any regenerated missing data components to form the content data.

14. The method of claim 13, wherein a data map describes which parity data corresponds with which data components.

15. A server comprising:
a network interface; and
logic configured to:
receive a request over a network for content data from a requester, the request including enablement information to enable retrieval of the content data from one or more storage locations;
process the enablement information to determine data allocation within the one or more storage locations;
retrieve content data in the form of separate data components from the one or more storage locations according to the determined data allocation; and
send to the requester the separate data components.

16. The server of claim 15, wherein the logic to process the enablement information is further configured to decrypt encrypted data allocation information using a decryption key.

17. A client for retrieving content data across a network, the client comprising logic configured to:
request for content data from a server, the request including enablement information to enable retrieval of the content data from one or more storage locations;
receive in response to the request of the separate data components; and
generate the content data from the separated data components.

18. The client of claim 17, wherein the logic configured to generate the content data from the separated data components further comprises logic configured to:
reconstruct the content data from a data map providing an indication of how the separate data components form the content data.

19. The client of claim 18, wherein the data components include identifiers corresponding to identifiers within the data map.

20. The client according to any of claims 17 to 19, wherein the separate data components include parity data and wherein the logic configured to generate the content data further comprises logic configured to:
regenerate any missing data components from the parity data and the remaining data components; and
reconstruct the received data components and any regenerated missing data components to form the content data.

21. The client according to any of claims 17 to 20, further comprises logic configured to generate a web page from the content data.

22. A method of storing content data comprising the steps of:
dividing the content data into a plurality of separate data components;
storing the separate data components within one or more storage locations;
generating data allocation information describing how the separate data components are allocated within the one ore more storage locations; and
generating a data map providing an indication of how the separate data components form the content data.

23. The method of claim 22 further comprising the step of generating an identifier for each separate data component and wherein the data map includes in its indication the identifiers for the separate data components.

24. The method of claim 22 or claim 23 further comprising the step of encrypting the data allocation information and/or the data map.

25. The method according to any of claims 22 to 24, wherein the content data is web content.

26. The method according to any of claims 22 to 25 further comprising the step of:
generating parity data for each data component and another data component of the plurality of message components.

27. The method of claim 26 further comprising the step of:
generating parity data for each data component and a second other data component of the plurality of data subsets.

28. The method of claim 26 or claim 27 further comprising the step of storing the generated parity data in the one or more storage locations.

29. A system comprising:
one or more servers according to claim 15 or 16; and
one or more clients according to any of claims 17 to 21.

30. A computer program comprising program instructions that, when executed on a computer cause the computer to perform the method of any of claims 1 to 14 or 22 to 28.

31. A computer-readable medium carrying a computer program according to claim 30.

32. A computer programmed to perform the method of any of claims 1 to 14 or 22 to 28.
